(19) United States
(12) Patent Application Publication
(10) Pub. No.: US 2004/0174869 A1
(43) Pub. Date: Sep. 9, 2004

(54) Switch and its usage

(76) Inventors: Masato Sone, Tokyo (JP); Yasuo Kawakami, Tokyo (JP); Kenji Suminaga, Tokyo (JP); Toku Hirase, Tokyo (JP); Taizou Horio, Tokyo (JP)

Correspondence Address: Matthew E. Connors, Gauthier & Connors LLP, Suite 3300, 225 Franklin Street, Boston, MA, 02110, US

(21) Appl. No.: 10/800,845

(22) Filed: Mar. 15, 2004

Related U.S. Application Data
(63) Continuation of application No. PCT/JP02/09343, filed on Sep. 12, 2002.

(30) Foreign Application Priority Data
Sep. 14, 2001 (JP) 2001-280448

(51) Int. Cl. H04Q 11/00

(52) U.S. Cl. 370/357

(57) ABSTRACT

A switching circuit is provided on a high frequency line forming a switch (SW). A plurality of switching circuits are provided for each high frequency line. A plurality of switching circuits provided at the same position are set as shunt circuits (S1, S2). In addition to providing a plurality of switching circuits at the same position, by separately providing a drive circuit for each switching circuit, the reliability can be improved. With a multiple-step structure in which a plurality of switching circuits are provided at different positions on the high frequency line, isolation between input and output is improved. By using a semiconductor element such as a PIN diode as a switching element within a switching circuit, it is possible to reduce numbers of maintenance services and maintenance personnel to facilitate usage, to reduce the size and cost, and to achieve high speed. By introducing a U-link in which a switching circuit and peripheral structures are made into a unit with a rigid line, the ease of maintenance and handling can be improved.

### TECHNICAL FIELD

The present invention relates to a switch for selectively connecting one of a plurality of inputs to a predetermined output and its usage. References related to the present invention include the following 6 references.

Reference 1: Japanese Patent Laid-Open Publication No. Hei 11-340945

Reference 2: Japanese Patent Laid-Open Publication No. 2000-261409

Reference 3: Japanese Patent Laid-Open Publication No. Hei 6-292157

Reference 4: Sunagawa et al., “Development of Non-stopping Wave Synthesis and Switch for VHF Television Broadcasting Device”, Technical Report of Institute of Television Engineers, vol. 14, No. 21, pp. 1-6, RDFT' 90-32, March, 1990.

Reference 5: Sunagawa et al., “Development of High Power Crossover Type Non-stopping Wave Switching System for VHF Band”, Technical Report of Institute of Television Engineers, RE81-28, pp. 77-82, Sep. 25, 1981.

Reference 6: PIN Diode Handbook, Microsemi Corporation, 1^{st} Ed., Jun. 1, 1996; which can be downloaded in PDF format from http://www.microsemi.com/literature/products/rf/pinbook.asp at the time of Sep. 4, 2002; in particular, Chapter One (http://www.microsemi.com/literature/products/rf/chapter%201.pdf).

### BACKGROUND ART

Redundancy in number of devices in wireless transmitters is an effective method for improving reliability. The “redundancy in number of devices” in this description refers to a process for, for example, using two wireless transmitters, one as a current transmitter and the other as a secondary transmitter, and connecting the current transmitter and the secondary transmitter to a transmission antenna through a switch. When there is redundancy in the wireless transmitters in this manner, it is possible to employ a usage configuration in which the current transmitter is connected to the transmission antenna and used in normal operations and the switch is operated and controlled to connect the secondary transmitter to the transmission antenna when there is a need for maintenance and reconditioning. Because of this, the reliability and quality of transmission service can be significantly improved compared to a configuration in which transmission is performed using a single wireless transmitter such as, for example, the possibility of continued transmission with almost no break except for the time necessary for operation of the switch and the ease of maintaining the wireless transmitters in good conditions. In addition, by using a switch having a mode for connecting a plurality of wireless transmitters to the transmission antenna, it is possible to simultaneously use the wireless transmitters (in this mode, there is no distinction between current and secondary) for transmission.

Because of these advantages, redundancy using a switch for selectively connecting one of a plurality of inputs to a predetermined output is employed in a system for which non-stop transmission service is demanded such as, for example, a ground wave television broadcast system. In this type of system, for example, two broadcasting devices (first and second broadcasting devices) are provided in a broadcasting station. An output broadcast signal from the first broadcasting device or from the second broadcasting device, for example, the output broadcast signal from the first broadcasting device, is supplied to the transmission antenna (or various circuits before the antenna; hereinafter collectively referred to as “transmission antenna”) via the switch. The signal radiated from the transmission antenna in this case is the broadcast signal output from the first broadcasting device. When it is desired to stop the first broadcasting device for some reason such as repairing of a failed component, the switch is operated and controlled so that the first broadcasting device is disconnected from the transmission antenna and the second broadcasting device is connected to the transmission antenna. The broadcasting is continued using the second broadcasting device. In this manner, by providing redundancy in the number of broadcasting devices and allowing selective use through use of a switch, it is possible to improve the reliability of a broadcast system, in particular, to continue transmission without a break at any arbitrary time including the time band during broadcasting, while performing a maintenance process or reconditioning process.

A problem associated with such a system of a plurality of transmitters is that the signal transmission is stopped for a very short period which is required for switching at the switch. This problem of short break in transmission becomes more significant as the transmission system transmits signals of higher information compression rate and as the system transmits modulated signals at a higher rate. For example, in Japan, commercial use of a ground wave digital television broadcast system is scheduled to start in the near future at the time the present application is filed. In the ground wave digital television broadcast system, data which is highly compressed is wirelessly transmitted, that is, broadcasted at a high rate using many carriers. Because of this, compared to a ground wave analog television broadcast system which has been conventionally put in service, the short break of broadcast waves is more problematic as the short break tends to cause deviation in the synchronization at the side of the television receiver etc. In consideration of this, conventionally, switches are developed and improved so that a signal route can be switched at the highest possible speed. In addition, particularly in a switch which handles high-power, high-frequency signals such as a switch for a broadcasting station, in addition to the high speed characteristic of the switching, it is necessary to ensure adequate isolation of the high-frequency signals and adequate tolerances for high-power signals, and thus, the switches have been conventionally developed and improved also from this point of view.

FIGS. 11 and 12 show a structure of a switch according to conventional art. FIG. 11 shows a switch constructed through a method called a multiple switch method and FIG. 12 shows a switch constructed through a method called a crossover method. These switches are described in the References 4 and 5 described above.

A device shown on FIG. 11 comprises a first input and a second input as input terminals to be connected to broadcasting devices and, as output terminals, a terminal to be connected to a transmission antenna ANT and a terminal to be connected to a dummy load RD for matching absorption. The first input is connected to switches SW1 and SW2 via a λ/2 line having λ/4 short stubs STB1 and STB2 at the center, wherein λ is a carrier wavelength of a broadcast signal. The second input is connected to the switches SW1 and SW2 via a λ/2 high frequency line having λ/4 short stubs STB3 and STB4 at the center. The switches SW1 and SW2 are each connected to the transmission antenna ANT via a λ/2 line and to the dummy load RD via a λ/2 line. Among the λ/2 lines, a portion of the line between the SW1 and ANT is realized by a λ/4 fixed matching device M1 and a portion of the line between the SW2 and RD is realized by a λ/4 fixed matching device M2.

In addition, the switches SW1 and SW2 each have a high frequency line for connecting between the first input and the transmission antenna ANT, a high frequency line for connecting between the second input and the transmission antenna ANT, a high frequency line for connecting the first input and the dummy load RD, and a high frequency line for connecting the second input and the dummy load RD. On the four high frequency lines in each of the switches SW1 and SW2, mechanical connection points are provided in order to allow/forbid signal transmission through the high frequency line, that is, to selectively control signal transmission on a line-by-line basis. Each of the mechanical connection points denoted by reference numerals 1-4 in FIG. 11 may be a contact type connection which involves mechanical opening and closing of contact or may be a non-contact type connection which involves connection via a capacitance. The connection points are driven by an electromagnetic solenoid which is exited or non-exited based on a drive signal supplied from a solenoid drive controller 10.

Therefore, by instructing, to the solenoid drive controller 10, a transmission route of, for example, “first input->transmission antenna ANT, second input->dummy load RD” and controlling the connection points 1 and 4 of the switch SW1 to close and connection points 2 and 3 of the switch SW1 to open, it is possible to broadcast using a broadcasting device connected to the first input (not shown) and, at the same time, absorb the output of a broadcasting device connected to the second input (not shown) at the dummy load RD. In addition, because two switches (SW1 and SW2) are provided in parallel, it is possible to couple the outputs from both broadcasting devices to increase the power and to radiate from the transmission antenna ANT.

A device shown in FIG. 12 comprises a hybrid HYB1 connected to two input terminals, that is, a first input and second input, a hybrid HYB2 connected to a transmission antenna ANT and a dummy load RD, and two phase shifters. Each phase shifter comprises a hybrid HYB3 or a hybrid HYB4 connected to the hybrids HYB1 and HYB2 and variable capacitors VC1 and VC2 or VC3 and VC4 which are connected to the hybrid HYB3 or to the hybrid HYB4 and having one terminal connected to the ground. The variable capacitors VC1-VC4 are driven by a drive signal supplied from a variable capacitor driver 20 so that the capacitance is varied. The hybrids HYB1-HYB4 are, for example, 3 dB hybrids. In front of the phase shifter shown at the lower portion of FIG. 12, a λ/4 short stub STB5 is provided.

A switch shown in FIG. 12 has three modes. These are a single operation mode of a first device in which an output of a broadcasting device connected to the first input (not shown) is radiated from the transmission antenna ANT, a single operation mode of a second device in which an output from a broadcasting device connected to the second input (not shown) is radiated from the transmission antenna ANT, and a parallel operation mode in which the outputs of both broadcasting devices are synthesized and radiated from the transmission antenna ANT. The variable capacitor driver 20 drives the variable capacitors VC1-VC4 within the phase shifters such that, in the single operation mode of first device, an amount of phase shift by the upper phase shifter is greater than an amount of phase shift by the lower phase shifter by 90° and, in the single operation mode of the second device, the amount of phase shift by the upper phase shifter is smaller than the amount of phase shift by the lower phase shifter by 90°. In the parallel operation mode, a phase difference of 90° is added between two inputs to cancel the effect of phase shifts.

The multiple switch method and the crossover method shown in FIGS. 11 and 12 have an advantage that because the connection point in these methods can be made into a connection point without mechanical opening/closing of a contact, the frequency of failure of the connection points can be reduced, and thus, reliability can be improved. However, although these methods do not involve mechanical contact, because a connection point having a mechanically driven portion (FIG. 11) or a variable capacitor (FIG. 12) is used, there is a tendency for variation in power or in phase to occur in the output from the transmission antenna ANT before, after, or during switching from the first input to the second input or from the second input to the first input. In addition, although the required time for switching can be reduced using a mechanical connection point or a variable capacitor, which does not involve mechanical opening/closing of a contact as the mechanical connection, because the connection is mechanical and thus contains a mechanically driven portion, there is a limit to the reduction in required time for switching. Even with a maximum possible reduction in time, in the method of FIG. 11, for example, approximately 500 msec would be required, and, in the method of FIG. 12, for example, a few seconds would be required for switching. Moreover, because the system of FIG. 11 uses many mechanical connection points, there is a problem in that maintenance of connection points is tedious and difficult, and the method of FIG. 12 has a problem in that the structure has poor isolation such as, for example, a slight amount of an output of the broadcasting device which is not being used for transmission leaks to the transmission antenna ANT, and thus, the isolation level is limited to approximately 40 dB.

### DISCLOSURE OF INVENTION

The present invention was conceived to solve the above-described problems, and an advantage of the present invention is that a switch is realized in which occurrence frequency of stopping of waves and damage due to malfunction and failure of connection points and periphery thereof is reduced and which is suitable for a broadcast station, relay station, or the like of a ground wave digital television broadcast system. Additional advantages of the present invention include identification of a portion where malfunction and failure occurred, improvement in isolation, inhibition of power variation and phase variation before, after, and during a switching period, reduction of required time for switching, improvement in the ease of operation such as maintenance and reconditioning, possibility of maintenance during daytime, reduction in size and/or cost, etc.

According to one aspect of the present invention, there is provided a switch for selectively connecting at least one of a plurality of inputs such as, for example, a plurality of broadcasting devices, to a predetermined output such as, for example, a transmission antenna. The switch comprises a plurality of high frequency lines for high-frequency connecting each input to the output; a switching circuit provided in each high frequency line for selectively blocking, line by line (that is, by suitably selecting one or more high frequency lines), the high-frequency connection; and a drive circuit for driving the switching circuit. The switch is characterized in that (1) a plurality of switching circuits are provided on at least one of the plurality of high frequency lines, and (2) the drive circuit is provided for each switching circuit.

Because a switching circuit within a switch is for selectively blocking a route for high-frequency connection through high frequency lines within the switch, fundamentally, only one switching circuit is required for each high frequency line. In the above-described one aspect of the present invention, however, a plurality of switching circuits are provided in (at least one of) the high frequency lines in order to improve reliability and/or isolation.

First, in order to provide a plurality of switching circuits on a high frequency line, there are several approaches including provision of a plurality of switching circuits at a same position on the high frequency line so that the switching circuits are in parallel to each other, provision of switching circuits at different positions on the high frequency line, and a combination of these. In the configuration where the switching circuits are provided in parallel at one position, even when any one of the switching circuits malfunctions or fails, as long as the other switching circuits provided in parallel with the malfunctioning or failed switching circuit are functioning normally, the control to allow/block high frequency connection in the corresponding high frequency line is unaffected, and therefore an advantage of improvement in reliability by redundancy can be obtained. In addition, because the switching circuits are in parallel, the contribution current in each switching circuit is reduced or the total current capacity or allowable dissipation is increased. In the configuration where the switching circuits are provided at different positions, on the other hand, the effects of isolation by each switching circuit can be multiplicatively obtained, and thus, the isolation in the overall high frequency line is significantly improved. A configuration of a combination of these, that is, a configuration in which a plurality of switching circuits are provided in parallel at each of different positions has both advantages of these configurations described above.

In addition, in a circuit structure in which a plurality of switching circuits are driven by one drive circuit, when one of the plurality of switching circuits malfunctions or fails, the malfunction or failure affects the operations of the drive circuit and the other switching circuits, resulting in possible loss of the advantages of improvements in reliability and in isolation. To this end, according to one aspect of the present invention, it is preferable that a drive circuit is provided for each switching circuit. With such a structure, because the drive circuits correspond to the switching circuits, it is possible to prevent spread of abnormality due to malfunction/failure, and, at the same time, it is possible to identify the portion where an abnormality occurred through detection of abnormality of switching circuits by drive circuits. In other words, in an example circuit in which a switching circuit within a switch is realized using a semiconductor element which conducts or blocks based on a bias voltage such as a PIN diode and the bias voltage is applied from a drive circuit to the semiconductor element within the corresponding switching circuit, it is possible for each of the drive circuits to determine the biasing situation in the semiconductor element of the corresponding switching circuit based on an output voltage or current from the drive circuit and to detect presence of occurrence of abnormality in the drive circuit or in the corresponding semiconductor element based on the result of the determination. In other words, it is possible to identify to which of the plurality of switching circuits provided on the same high frequency line the malfunction/failure is related.

Moreover, the switching circuit may be of a series circuit type or of a shunt circuit type. A series circuit is a circuit having a structure in which a switching element is serially connected with respect to a central conductor of a high frequency line and a shunt circuit is a circuit having a structure in which the switching element is connected between the central conductor and a grounding conductor of the high frequency line. In an example structure in which a semiconductor element is used as the switching element, for example, a series circuit is a circuit in which the semiconductor element is inserted on a central conductor of a corresponding high frequency line such that transmission through the high frequency line is allowed when the semiconductor element is conductive and the transmission is blocked when the semiconductor element is not conductive. A shunt circuit, on the other hand, is a circuit in which the semiconductor element is inserted between the central conductor and a grounding conductor of the corresponding high frequency line such that the transmission through the high frequency line is blocked when the semiconductor element is conductive and is allowed when the semiconductor element is not conductive. By using a semiconductor element, it is possible to reduce the time required for switching, which allows for inhibition of power variation and phase variation before, after, and during switching and for reduction in size and cost of the switch. Because of this, in addition to the above-described advantages of redundancy and improvement in isolation, ease of operation for maintenance and reconditioning by the possibility for identifying the malfunctioned/failed portion, and possibility of maintenance during daytime, a further advantage can be obtained in that a switch can be realized which is suitable to a broadcast station, relay station, or the like of a ground wave digital television broadcast system. From the viewpoint of the reduction in the time required for switching, it is preferable to temporarily control to increase or decrease a value of the bias voltage or current when bias of the semiconductor element (for example, PIN diode) in a switching circuit is switched between forward bias and reverse bias, more particularly, to control the value of the bias voltage or current to shorten the time required for switching among the increasing or decreasing control. A circuit for this purpose may be provided in addition to the drive circuit or within the drive circuit.

In addition, in general, if only one series circuit is provided for each high frequency line, no λ/4 line (a line having an electrical length of an odd number multiple of λ/4, wherein λ is a carrier wavelength of a signal transmitting through the high frequency line; hereinafter the term “λ/4 line” refers to this structure) for isolation between an input and an output is required, and thus, such a high frequency line is not bound by a bandwidth limitation by the λ/4 line and is suited for a wide-bandwidth design. In a shunt circuit, on the other hand, because one of electrodes of the semiconductor element can be connected to the grounding conductor, the shunt circuit more easily allows heat to escape through the connection and has better heat dissipating characteristics. Thus, the shunt circuit is more suited for use in broadcasting devices which handle high-power, high-frequency signals. When a plurality of switching circuits are provided at a position, a shunt circuit would probably be used. In this case, in order to prevent a bias voltage appearing on the central conductor and grounding conductor of the corresponding high frequency line, it is preferable to add a capacitor to the shunt circuit for blocking a direct current. This capacitor also has a function to protect the semiconductor element against lightning surge and other excessive input/noise input. When a shunt circuit is to be used, it is preferable to ensure isolation by providing λ/4 lines between the shunt circuit and the input and between the shunt circuit and the output. In addition, when a shunt circuit is to be provided in different positions on a high frequency line, it is preferable to provide λ/4 lines between the shunt circuits to secure isolation.

When power of a signal to be handled is large, it is preferable to use a low impedance method when a shunt circuit is used. The low Impedance method suggested by the inventors of the present invention is a method to allow a semiconductor element having a relatively low voltage specification to handle a higher power (higher frequency) signal by inhibiting the voltage applied to the shunt circuit, in particular, to the semiconductor element, using a λ/4 line. Specifically, in this method, the intrinsic impedance of a first line portion of the high frequency line, including a portion in which the shunt circuit is provided (shunt circuit provision position), is set to be lower than the intrinsic impedances of two second line portions located between the first line portion and the input, and between the first line portion and the output. The first line portion is set to be a λ/2 wavelength line (which is a line having an electrical length of a natural number multiple of λ/2; hereinafter the term “λ/2 wavelength line” refers to this structure). If it is assumed that the intrinsic impedance of the second line portion is Z0, that the intrinsic impedance of the first line portion including the shunt circuit provision position is Z0/2; and that the line portion of intrinsic impedance of Z0 is provided at the center of the line portion, the impedance when the central portion of the first line portion is seen from one end of the first line portion is Z0/4, and thus, the voltage of the central portion of the first line portion is ¼^{1/2}=½ compared to a structure in which the entire length of the high frequency line is made into a Z0 line. Therefore, by providing a shunt circuit in any position on the first line portion, it is possible to allow a use of a low-voltage specification semiconductor element. Regarding an increase in current due to reduction in voltage, it is possible to deal with this situation by making the shunt circuits (semiconductor elements) parallel or increasing the number of parallel circuits. In this case also, it is preferable to provide a drive circuit for each switching circuit.

In addition, it is also possible to use both a series circuit and a shunt circuit as the switching circuits within a switch according to another aspect of the present invention. In this case, it is preferable to use, among a plurality of high frequency lines connected to the same input or output, series circuits as the switching circuits in one or more of the high frequency lines and shunt circuits as the switching circuits in the remaining high frequency lines. The drive circuit is provided to correspond to the series circuit. The shunt circuit is driven by the drive circuit corresponding to the series circuit. In this structure, a bias voltage supply route from the drive circuit to the shunt circuit is provided corresponding to the shunt circuit. In this manner, it is possible to drive a plurality of switching circuits using a single drive circuit. By additionally providing, in an input, in an output, or on a high frequency line, a capacitor for serially blocking the input and the output with respect to the drive circuit, it is possible to make a line portion from the position in which the series circuit is provided (series circuit provision position) to the position in which the shunt circuit is provided, among the plurality of high frequency lines to function as the bias voltage supply route from the drive circuit provided corresponding to the series circuit to the shunt circuit. In other words, it is possible to not separately provide a bias signal line for sharing the drive circuit.

When a shunt circuit is to be provided, it is preferable to incorporate a countermeasure against abnormal heat generation as a structural devise. For example, an automatic detachment component maybe provided in the shunt circuit, which separates, when an element of the shunt circuit such as, for example, a semiconductor element or a capacitor generates excessive heat, the shunt circuit or the heat-generating element from the central conductor of the corresponding high frequency line. As the automatic detachment component, for example, a component such as a thermal fuse can be used. By using a component having flexibility or a cushioning characteristic such as a thermal fuse, it is possible to desirably prevent damage to a shunt circuit when mechanical and/or thermal stress is applied to the line portion in which the shunt circuit is incorporated. The automatic detachment component is not limited to a component, and may be a structure which is usually not recognized as a component by itself, such as, for example, low-melting point solder.

In addition, it is preferable to devise the installation form of the high frequency line such that the portion of the high frequency line to which the shunt circuit or the like is incorporated can be separated and exchanged.

First, an arbitrary high frequency line within a switch may be considered as having separate portions: a line portion on the side of the switching circuit (hereinafter referred to as “switching circuit-side line portion”) in which one or a plurality of switching circuits are provided and two line portions on the side of a terminal (hereinafter referred to as “terminal-side line portion”) present between the switching circuit-side line portion and the input and between the switching circuit-side line portion and the output. The switching circuit-side line portion is constructed such that a λ/4 wavelength line portion which is a portion of the switching circuit-side line portion is interposed between a switching circuit, among the switching circuits provided in the switching circuit-side line portion, which is the closest to the terminal-side line portion and the terminal-side line portion. In this manner, isolation of a group of switching circuits with respect to the terminal-side line portion can be ensured. On the other hand, each of the terminal-side line portions is set as a line portion extending from the input or from the output by an electrical length of a natural number multiple of λ/2 wavelength. With such a structure, isolation of a connection point between the terminal-side line portion and the switching circuit-side line portion with respect to the input and output can be ensured. Therefore, (when no high frequency current is flowing through the semiconductor element in the switching circuit) even when the switching circuit-side line portion is separated from the high frequency line in response to some need, there is no particular influence on the function of the other portions of the switch or to the operation of the switch.

Taking advantage of this structure, in a preferred embodiment of the present invention, a U-link is formed which is a unit for storing a switching circuit or a drive circuit along with a switching circuit. The U-link is formed by creating a unit of the switching circuit-side line portion as described above, is provided to be detachable from the terminal-side line portion, and has a shape which can hold or pinch, such as, for example, a shape similar to a handle or a staple. If the high frequency line is a rigid line, the attaching/detaching process of the U-link is particularly easy and the U-link can be easily handled. When a shunt circuit is stored within the U-link as the switching circuit, a capacitor for blocking direct current can be provided in the shunt circuit to allow prevention of bias voltage applied to the semiconductor element within the shunt circuit to appear on the housing of the U-link. Because of this, even when the bias voltage is high, the voltage does not appear on the outer surface of the U-link or the like, and therefore, the high voltage does not impede or endanger work activities. In addition, by providing a switch on a panel onto which the U-link is to be provided and configuring to detect that the U-link is detached or is about to be detached from the panel by using the switch, it is possible to stop the bias voltage or the like based on the detection. Furthermore, when using the switch, it is desirable to prepare a non-element U-link. A “non-element U-link” in this description refers to a line portion unit which can be attached to the disposition panel of the U-link in place of the U-link, but does not have a switching circuit therein. By attaching/detaching the non-element U-link on the panel, switching which does not depend on the switching circuit, that is, a manual force-requiring switching can be realized, which is useful in emergency situations.

### BRIEF DESCRIPTION OF DRAWINGS

FIG. 1 is a circuit diagram showing a structure of a switch according to a preferred embodiment of the present invention.

FIG. 2 is a circuit diagram showing a structure of a switching circuit according to a preferred embodiment of the present invention.

FIG. 3 is a diagram showing a structure of a shunt circuit according to a preferred embodiment of the present invention.

FIG. 4 is a side view showing an outline of a U line according to a preferred embodiment of the present invention.

FIG. 5 is a partial circuit diagram showing an alternative preferred embodiment of the present invention.

FIG. 6 is a diagram showing an alternative example switching circuit to each of FIG. 6(a) and FIG. 6(b) according to a preferred embodiment of the present invention.

FIG. 7 is a circuit diagram showing a structure of an alternative switch according to a preferred embodiment of the present invention.

FIG. 8 is a circuit diagram showing a structure of a switching circuit in the alternative switch.

FIG. 9 is a circuit diagram showing a structure of a switch according to another alternative embodiment.

FIG. 10 is a diagram showing an example of a high frequency line in another alternative embodiment, wherein FIG. 10(a) shows a circuit structure and FIGS. 10(b)-10(d) show an attachment principle of a high frequency line.

FIG. 11 is a circuit diagram showing a structure of a switch according to a conventional art.

FIG. 12 is a block diagram showing another switch according to a conventional art.

FIG. 13 is a diagram showing an example drive circuit according to a preferred embodiment of the present invention.

FIG. 14 is a flowchart showing a procedure for reducing time required for switching through control of bias power supply.

In these diagrams, reference numerals 31, 32, and 35-37 represent drive circuits; reference numerals 33 and 34 represent a diode mounting portion; reference numeral 43 represents a controller circuit; reference numeral 44 represents a positive power supply; reference numeral 45 represents a negative power supply; a-h represent positions of the ends of U-links; A-H, a, and β represent shunt circuits provision positions; ANT represents a transmission antenna; C1-C6, C11, C12, C21, C22, C3a, C3b, C4a, and C4b represent capacitors; D1, D1a, D1b, D11, D11a, D11b? D12, D2, D2a, and D2b represent PIN diodes; F represents a thermal fuse; L1-L3, L1, L11a, L11b, L12, L2a, and L2b represent inductors; R1-R4 represent series circuits; RD represents a dummy load; S, S1, and S2 represent shunt circuits; S1l and S21 represent semiconductor switches; SW represents a switch; U and U1-U4 represent U-links; Z0 represents an intrinsic impedance; γ and δ represent positions where series circuits are provided; and λ represents a wavelength.

### BEST MODE FOR CARRYING OUT THE INVENTION

A preferred embodiment of the present invention will now be described referring to the drawings. In the following description, the preferred embodiment of the present invention will be described referring to an example structure in which a switch of the present invention is used in order to realize a two-broadcasting device system in a ground wave television broadcasting station. This, however, is only for the purpose of simplification of description and should not be interpreted as limiting the application range of the present invention. In other words, it is clear from the following description that the present invention can be applied to any switch which requires high reliability, high quality, low cost, etc., in particular, to a switch which may handle a high-power, high-frequency signal.

(1) Basic Structure

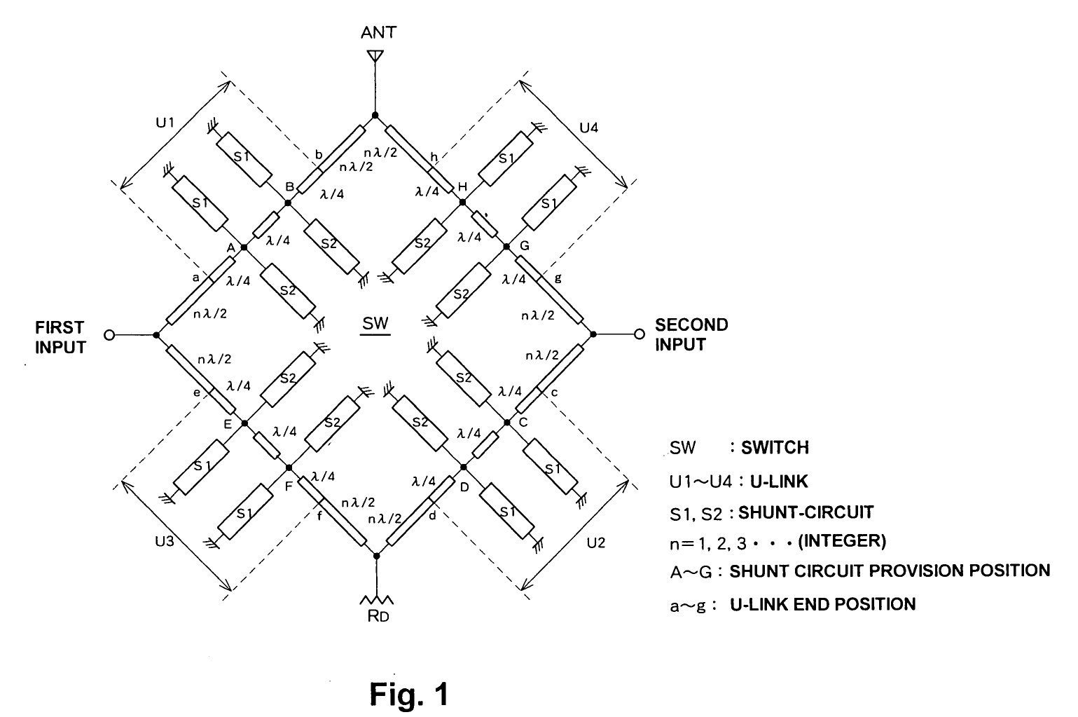

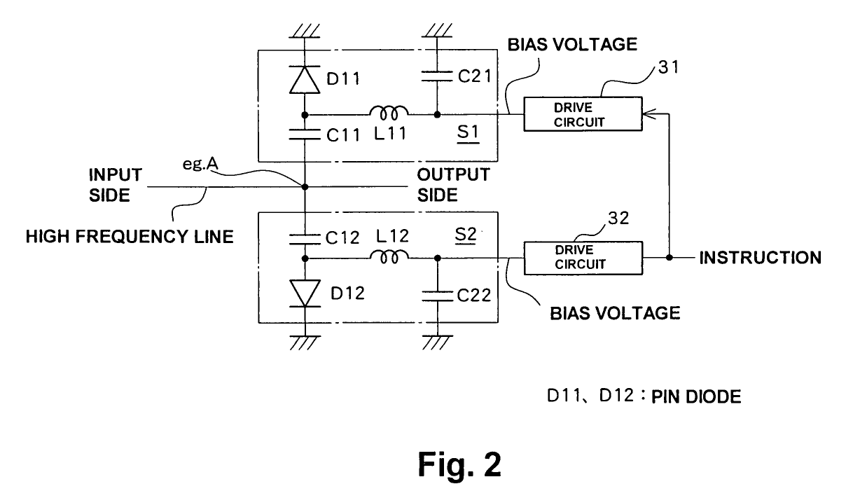

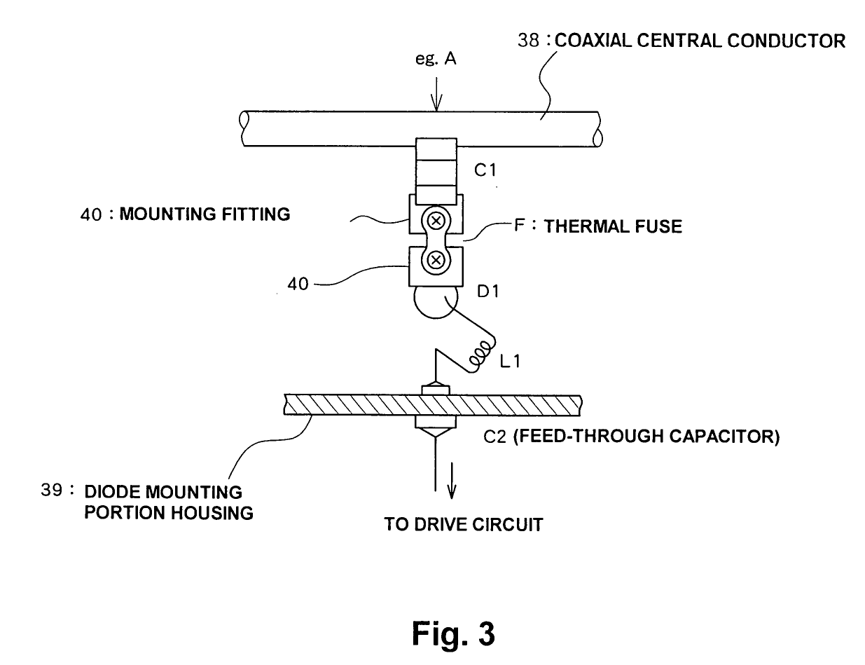

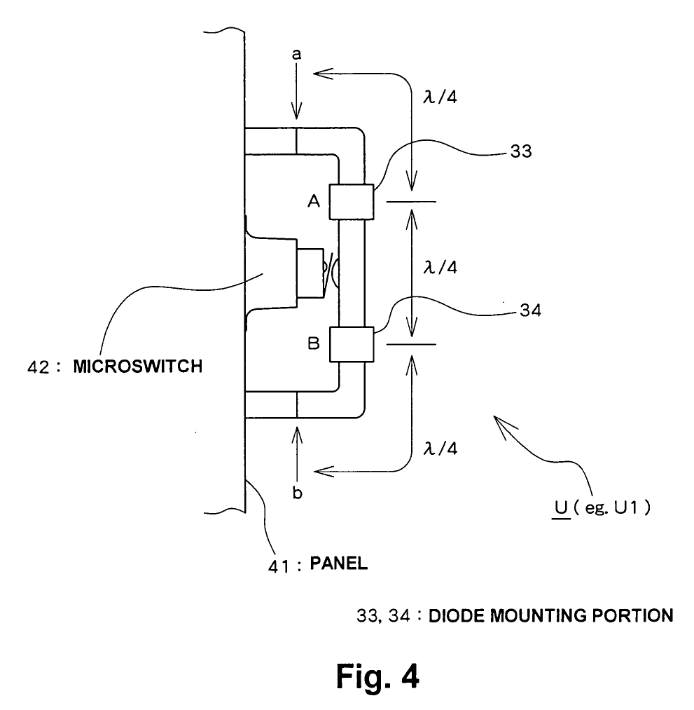

FIG. 1 shows a structure of a switch for a broadcasting station according to a preferred embodiment of the present invention, FIG. 2 shows a structure of a switching circuit of the switch and a relationship between the switching circuit and a drive circuit, FIG. 3 shows a structure of a shunt circuit which forms the switching circuit, and FIG. 4 shows an example of a U-link which is a unit including the shunt circuit. As shown in FIG. 1, a switch SW according to the present embodiment comprises a first input and a second input as input terminals for connecting to broadcasting devices which are inputs, an output terminal for connecting to an output such as, for example, a transmission antenna ANT, and an output terminal connected to a dummy load RD for matching-ending and absorbing an output of a broadcasting device which is not connected to the transmission antenna ANT. In the switch SW, four high frequency lines are provided and two sets of shunt circuits are provided on each high frequency line.

Referring to a high frequency line connecting the first input and the transmission antenna ANT as an example, as shown in FIG. 1, a set of shunt circuits S1 and S2 is provided at a position A on the high frequency line which is separated from the first input by nλ/2+λ/4 in electrical length (wherein λ represents a carrier wavelength of the broadcasting signal), another set of shunt circuits S1 and S2 is provided at a position B on the high frequency line which is separated from an output terminal to the transmission antenna ANT by nλ/2+λ/4 in electrical length, and a line having an electrical length of λ/4 is provided between the shunt circuit provision position A and the shunt circuit provision position B. Shunt circuit provision positions C and D on a high frequency line for connecting the second input and the dummy load RD, shunt circuit provision positions E and F on a high frequency line for connecting the first input and the dummy load RD, and shunt circuit provision positions G and H on a high frequency line for connecting the second input and the transmission antenna ANT satisfy similar relationships with respect to the input and output terminals connected to the respective high frequency line and are positions at which a pair of shunt circuits S1 and S2 are provided.

As shown in FIG. 2, the shunt circuits S1 and S2 have a circuit structure in which anodes of PIN diodes D11 and D12 are connected to a central conductor of the high frequency line via capacitors C11 and C12 and cathodes of the PIN diodes D11 and D12 are connected to a grounding conductor of the high frequency line. Although not shown in FIG. 1, drive circuits 31 and 32 for driving the PIN diodes D11 and D12 in the shunt circuits S1 and S2 are provided corresponding to each of the shunt circuits S1 and S2 as shown in FIG. 2. The drive circuits 31 and 32 apply a bias voltage to the cathodes of the PIN diodes D11 and D12 via inductors L11 and L12 and C21 and C22 which form low-pass filters (LPF). In addition to applying a bias voltage to the corresponding PIN diodes D11 and D12 in response to an instruction supplied from the outside, the drive circuits 31 and 32 monitors the bias voltage actually applied to the PIN diodes D11 and D12 and current flowing through the PIN diodes D11 and D12, to detect occurrence of abnormality in the corresponding shunt circuits S1 and S2 including the PIN diodes D11 and D12. The result of the detection is promptly supplied to a user or to an external device from the drive circuits 31 and 32 through notification means which is not shown.

FIG. 3 shows an example of a specific structure of the shunt circuit. FIG. 3 shows a structure of one shunt circuit and it should be noted that, in reality, a number of shunt circuits having a structure of FIG. 3 are provided, the number corresponding to the number of shunt circuits shown in FIG. 1. In a structure of FIG. 3, as the high frequency line to which the shunt circuit is to be provided, a coaxial line is considered in which a gas-phase dielectric material or vacuum is provided between a central conductor and a grounding conductor, in particular, a rigid coaxial line in which the rigidity of the grounding conductor which is the outer conductor is high. The shunt circuit is stored between a coaxial central conductor 38 which is an inner conductor of the coaxial line and a grounding conductor which is an outer conductor of the coaxial line. In FIG. 3 and FIG. 4 which will be described later, the portion in which the shunt circuit, in particular its PIN diode (and in some cases, a portion of the drive circuit), is stored is called a “diode mounting portion” and the grounding conductor forming an outer periphery or an inner separation of the diode mounting portion is called a “diode mounting portion housing 39”.

Among the members shown in FIG. 3, the PIN diode D1 corresponds to structures D11 and D12 shown in FIG. 2. The anode of the PIN diode D1 is connected to an outside of the diode mounting portion via an inductor L1. The inductor L1 corresponds to the structures L11 and L12 shown in FIG. 2. The cathode of the diode D1 is connected to the diode mounting portion housing 39 or a conductor (not shown) which is connected to the housing 39. On the diode mounting portion housing 39, a feed-through capacitor C2 is mounted and one terminal of the inductor L1 extends, via a center of the feed-through capacitor C2, towards the drive circuit which is outside the diode mounting portion. In other words, the capacitor C2 corresponds to the structures C21 and C22 shown in FIG. 2. Moreover, the capacitor C1 is a component corresponding to structures C11 and C12 shown in FIG. 2 and is connected to the coaxial central conductor 38 at predetermined shunt circuit provision position.

In addition, in a structure shown in FIG. 3, a thermal fuse F is incorporated using a pair of mounting fittings 40. The mounting fittings 40 are components having good conductivity, and one of the mounting fittings is connected to the capacitor C1 and the other is connected to the anode of the diode D1. The thermal fuse F provided between mounting fittings 40 is made of a material which is conductive and which melts and breaks at a relatively low temperature. That is, when an element of the shunt circuit such as the diode D1, capacitor C1, etc. generates heat and the temperature of the thermal fuse F becomes greater than a predetermined temperature, the thermal fuse F melts and is disconnected, and the capacitor C1 and PIN diode D1 are disconnected from each other. The material of the thermal fuse F also has flexibility and cushioning characteristics, and absorbs at least some of deformation due to stress when stress caused by thermal expansion or the like is applied to the diode portion, in order to prevent damage to the shunt circuit and to the conductive lines inside and outside the shunt circuit.

Each of the high frequency lines shown in FIG. 1 includes a shunt circuit-side line portion (U1-U4) and a terminal-side line portion which is a portion other than the shunt circuit-side line portion. Referring to the high frequency line connecting the first input and the transmission antenna ANT as an example, portions sandwiched by two terminal-side line portions, that is, portions from point a via point A and point B to point b, are the shunt circuit-side line portion. Between the shunt circuit provision position A and the shunt circuit provision position B, a λ/4 line is provided to allow isolation between the positions A and B and λ/4 lines are provided between the shunt circuit provision position A and point a and between the shunt circuit provision position B and point b to allow respective isolation. As a result, the electrical length of the shunt circuit-side line portion becomes 3λ/4. The portion extending from the first input to the point a and the portion extending from the output terminal to the transmission antenna ANT to the point b are the terminal-side line portions. The electrical length of each terminal-side line portion is set at nλ/2 (n is an integer greater than or equal to 1) in order to ensure isolation between the first input and the point a or between the output terminal to the transmission antenna ANT and the point b and to allow or facilitate detachment of the U-link. If detachment/attachment of U-link are not required, that is, if the structure of U-link is not employed, n may be 0.

As shown in FIG. 4, a U-link refers to a structure in which a shunt circuit-side line portion is constructed from a rigid coaxial line and a shunt circuit (and a portion of the drive circuit) having a structure shown in FIG. 3 is stored in diode mounting portions 33 and 34 which are portions of the U-link. For example, a U-link U1 is a line portion including shunt circuit provision positions A and B and ends of the U-link U1 correspond to points a and b in FIG. 1. A U-link U is a pipe having a “U” shape or “C” shape similar to a handle or a staple. The U-link can be separated from or mounted onto the switch SW at end positions (points a and b in U1, for example). Because of this structure, one terminal of the terminal-side line portion is placed on a panel 41 of the switch SW to which the U-link U is to be mounted, corresponding to the shape and size of the U-link U. In addition, on the panel 41 to which the U-link U is to be mounted, a microswitch is provided such that the connection point opens as the U-link U is separated from the panel 41, that is, such that when an operator or a predetermined tool/device contacts the U-link U and detachment operation of the U-link U is started, the start of the detachment operation can be detected.

(2) Advantages

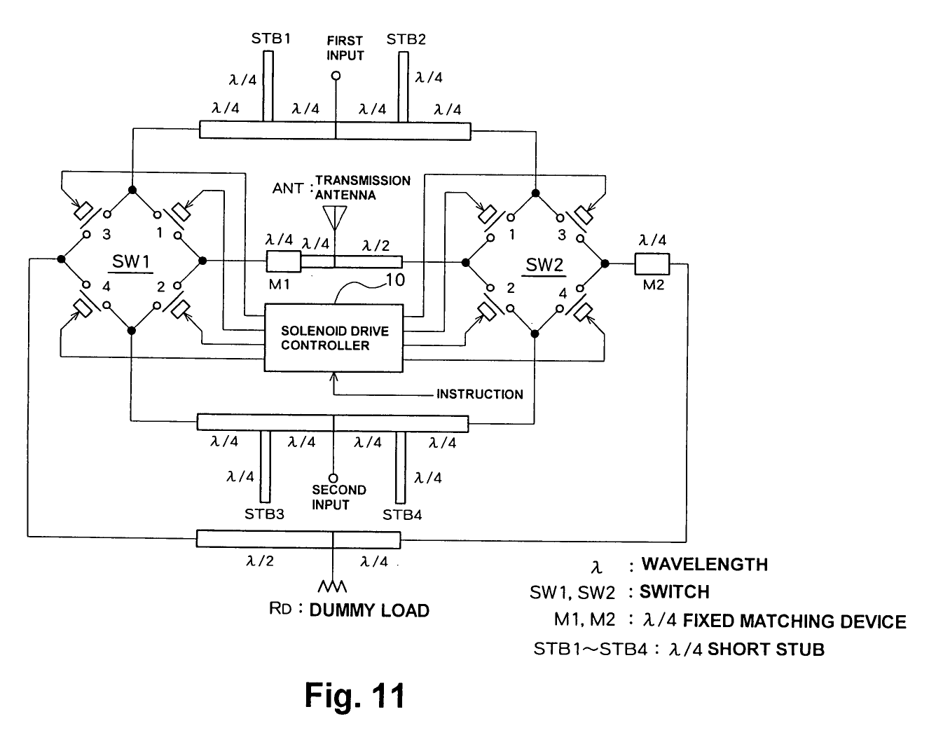

As described, in the present embodiment, shunt circuits S1 and S2 which use PIN diodes D11 and D12 as the switching elements are provided in place of mechanical connection points 1-4 in the switch SW1 or SW2 in a multiple switch method shown in FIG. 11. Because a semiconductor switching element is used, the time required for switching is shorter compared to the multiple switch method having mechanical connection points and the crossover method having a mechanism for driving variable capacitors. Depending on the realization form, usage, and required specification of the circuit, it is possible to realize a high-speed switch which can be switched with a time of approximately 1 μsec. Moreover, for the same reason that there is no mechanical driver present, power variation and phase variation in the output of the transmission antenna before, after, and during switching tend not to occur, and thus, synchronization deviation at the side of the receiver device tends to occur less frequently. Furthermore, with the use of PIN diodes which are semiconductor elements, the size and cost can be reduced, and reduction in number of maintenance operations and in number of required maintenance personnel can also be achieved.

In particular, in a ground wave digital television broadcast system, because a guard interval which is a period in which a portion of data is repeated is provided in the broadcasting signal as a countermeasure to multipath problems, a temporary interruption or phase shift within the length of the guard interval can be absorbed in the receiver device. Therefore, by also employing a guard interval synchronization switching method such as, for example, detecting the guard interval and switching the switch SW in synchronization with the guard interval timing, it is possible to desirably inhibit influences of temporary interruption or the like. In other words, the switch SW according to the present embodiment is a switch suited for a broadcasting station or a relay station of ground wave digital television broadcasting. Refer to the references 1 and 2 described above regarding the guard interval detection or the like.

In the present embodiment, a shunt circuit is used as the switching circuit. As shown in FIGS. 2 and 3, a shunt circuit can be formed to have a circuit structure in which an electrode of a switching element (in the embodiment, cathode of PIN diode) is connected to a grounding conductor. Because of this structure, it is easy to allow heat generated in the switching element to transfer to the grounding conductor, and thus, the shunt circuit is superior in heat dissipating capabilities. In a switch which handles a high-power, high-frequency signal such as a switch for a broadcasting device, in order to secure stability and reliability, it is preferable to use a shunt circuit which has superior heat dissipating capability. By ensuring the heat dissipating capability, it is possible to inhibit malfunctioning and failure of the switch SW, in particular, in the switching element, and thus to reduce the probability and frequency of occurrence of interruption of waves and damage.

In addition, in the present embodiment, two shunt circuits S1 and S2 are provided in parallel at a same position on the high frequency line. Because of this structure, a current capacity, an allowable dissipation, or the like is higher compared to a configuration in which only one shunt circuit is provided, allowing for the structure to handle higher power and for load distribution (derating) effects.

In addition, in the present embodiment, a pair of shunt circuits are provided in each of two positions on the same high frequency line (two-step connection). Therefore, isolation between the input and output in the present embodiment is high. If it is assumed that an isolation of N (dB) can be obtained in one step, the isolation can be increased corresponding to the number of steps such as, for example, 2N (dB) for two steps and 3N (dB) for three steps, and thus, it is preferable that the number of steps be as large as possible within a range allowed by the scale, cost, etc. of the circuit. Between the steps, it is preferable to provide a λ/4 line as shown in FIG. 1 to ensure isolation between the steps. When content or signal condition of a broadcast signal output from a broadcasting device connected to the dummy load RD via the switch SW is to be checked, if the broadcast signal output from the broadcasting device connected to the transmission antenna ANT leaks to the side of the dummy load RD, accurate reading cannot be obtained, which is disadvantageous. In the present embodiment, because isolation between the input and output is high as described above, such disadvantageous effects tend not to occur, and it is possible to desirably perform inspection of signal contents and signal conditions during broadcasting hours (daytime maintenance). The inspection does not need to be performed late at night or early in the morning outside broadcasting hours. In addition, burden on the equipment such as provision of separate switches for daytime maintenance can be reduced.

In the present embodiment, drive circuits 31 and 32 are individually provided for each of the shunt circuits S1 and S2. Therefore, even if a short-mode failure or voltage-resistance degradation occurs in the shunt circuit S1, because a bias voltage is still supplied to the shunt circuit S2 from a drive circuit 32 which is a bias voltage source independent from the drive circuit 31, substantially no change occurs in the biasing condition of the PIN diode D12 in the shunt circuit S2, and the condition of the high frequency circuit is maintained in a condition similar to before the failure. As a result, improvements in reliability through redundancy can be obtained and the possibility of interruption of waves is reduced.

Each drive circuit in the present embodiment detects the occurrence of abnormality in the corresponding shunt circuit by monitoring a bias voltage actually applied to the shunt circuit and current flowing through the shunt circuit, in particular, the PIN diode. Because a drive circuit is provided corresponding to a shunt circuit, it is possible to identify in which of the shunt circuits the abnormality occurred by knowing in which of the drive circuit the abnormality is detected. With this structure, it is possible to accurately and quickly identify the position where an abnormality occurred, at least down to a shunt circuit, by gathering abnormality detection states at each drive circuit. In this manner, when an abnormality occurs, the abnormality can be dealt with quickly.

During forward bias, when the PIN diode suffers a short circuit failure, the current increases. When the PIN diode suffers an open circuit failure, no current flows. In other failures in various “in-between” modes, a current different from a normal current flows. During reverse bias, on the other hand, when the PIN diode suffers a short circuit failure, because the reverse bias voltage is high, current increases significantly. When the PIN diode suffers an open circuit failure, no current flows. In other failures in various “in-between” modes, such as voltage resistance degradation, a current different from normal current flows. Therefore, by measuring or calculating, in advance, the current value at normal mode corresponding to different categories such as forward and reverse bias, and by the drive circuit periodically measuring a current flowing through the corresponding shunt circuit at a predetermined interval during actual usage, it is possible to determine the failure mode in the drive circuit by comparing the measured or calculated current value with the normal current value obtained in advance, in consideration of the bias condition, and to allow detection of failure of drive circuit itself. It is particularly desirable that changes in temperature and variation among components be considered during this process. For example, in general, at a higher temperature, the current flow increases. Therefore, it is possible to detect a condition in which the device is not failing but heat is being generated. In addition, when a short mode failure occurs during reverse bias, the power supply capacity becomes insufficient and the voltage is reduced or a protection circuit is operated and the supply of power is stopped, it is effective to monitor the bias voltage or the power supply condition of the drive circuit in order to detect such failure.

In the present embodiment, the shunt circuits S1 and S2 are connected to the central conductor of the high frequency line via capacitors C11 and C12, respectively. Tolerance of the shunt circuits S1 and S2 with respect to lightning surge or the like is therefore high. The reliability is also improved in this respect.

In addition, in the present embodiment, a thermal fuse F is provided which melts and is disconnected when abnormal heat is generated in the PIN diode D1 or in the capacitor C1. With this structure, because it is possible to separate, from the high frequency line, the PIN diode D1 or the like in which abnormal heating occurs, the possibility of inability to control and consequently, occurrence of interruption of waves or the like is reduced. By using a flexible and cushioning material as the temperature fuse F, it is possible to absorb stress due to thermal expansion or the like by the temperature fuse F to reduce the occurrence of damage. In place of the thermal fuse F, it is also possible to use a low-melting point solder or the like.

In addition, in the present embodiment, the shunt circuit-side line portion is made into a U-link. Therefore, it is possible to detach the U-link U from the panel 41, that is, to force fully separate the U-link U from the terminal-side line as necessary. With this structure, it is possible to desirably handle situations in which driving of the shunt circuit by the drive circuit cannot be normally performed because some abnormality occurred in a controller device (not shown), by detaching the U-link and switching manually and forcefully. By automatically switching off a forward bias power supply when start of detachment is detected by a microswitch 42, it is possible to detach in a condition in which no high-frequency power is applied to the PIN diode. Similarly, when start of detachment is detected by the microswitch 42, the reverse bias power supply is automatically switched off and broadcasting devices are also switched off if possible. However, because the bias voltage is blocked by the capacitor C2, no direct voltage (at least a high voltage such as the reverse bias voltage) appears on the outer surface of the U-link U, which allows for continuation of broadcasting without stopping the reverse bias power supply or the broadcasting device. In addition, it is possible to prepare a non-element U-link in which no switching element such as PIN diode or switching circuit is provided and to use the switch without depending on the switching circuit.

(3) Alternative Embodiment

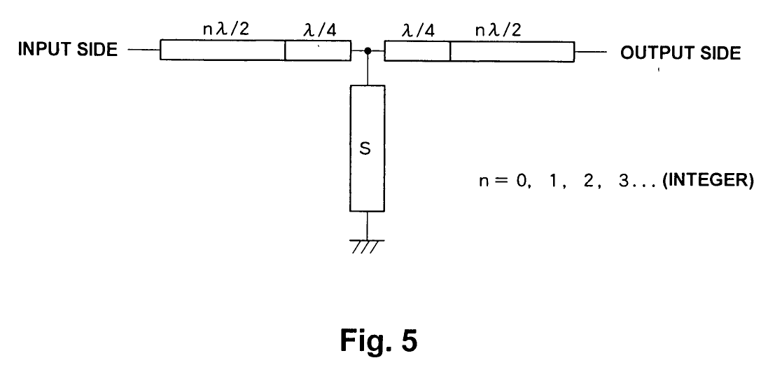

Various modifications can be made to the above-described embodiment. In the structure of FIG. 1, a pair of shunt circuits S1 and S2 are provided at each of two positions on a high frequency line. However, when the required degree of isolation is lower, the shunt circuits may be provided only at one position, and, when the required degree of isolation is higher, the shunt circuits may be provided in three or more positions. In addition, in the above-described embodiment, two shunt circuits are provided in parallel for each position, but it is possible to provide only one shunt circuit for each position if the high frequency line does not particularly require redundancy, or to provide 3 or more shunt circuits for each position if the scale, cost, etc. of the device allows for such a configuration. The simplest structure is a structure in which one shunt circuit (shunt circuit S) is provided at one position on the high frequency line as shown in FIG. 5, and a multiple-step structure and a parallel structure will be suitably selected based on the required isolation and reliability. Moreover, if no separation of the switching circuit-side line portion such as a U-link is performed, it is possible to set n to zero.

In the above-described embodiment, a PIN diode is used as a semiconductor switching element. It is also possible to use a transistor such as a MESFET as the switching element, but it is particularly desirable to use a PIN diode when a high-power signal is handled. The direction of the PIN diode may be opposite to that shown on FIG. 2, in which case, the polarity of the bias voltage is also reversed. When an NIP diode is used, the polarity is similarly changed.

In order to realize high impedance of the PIN diode at a high frequency, a sufficient reverse bias voltage must be supplied. That is, when a high-frequency power is applied while application of reverse bias voltage is insufficient, problems such as generation of spurious power occur. As such, it is preferable to apply redundancy also to the power supply such as, for example, supplying power to each drive circuit from both of the two broadcasting devices in order to prevent supplying power to the drive circuit. With such a structure, it is possible to realize a PIN diode type switch in which spurious power or the like tends to not occur. When a PIN diode is to be used in a switch which handles a high power, it is necessary to use a power supply of sufficiently high voltage as the power supply for reverse bias, but because a high voltage power supply has a higher impedance than a low voltage power supply, the advantage of reduced required time of switching may be lost. In consideration of this point, it is desirable to switch power supply at multiple steps when switching to reverse bias to ensure the advantage of reduced time required for switching which is one of the advantages which can be obtained using the semiconductor switch.

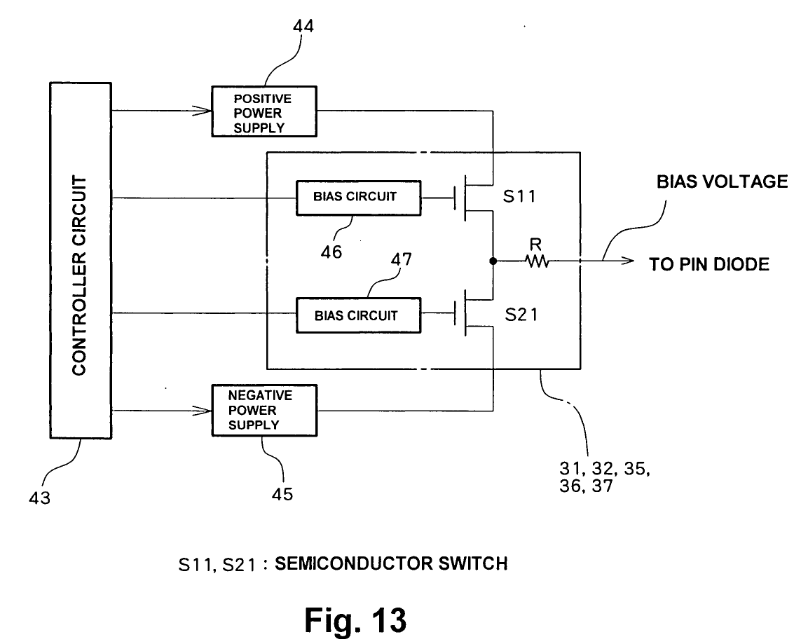

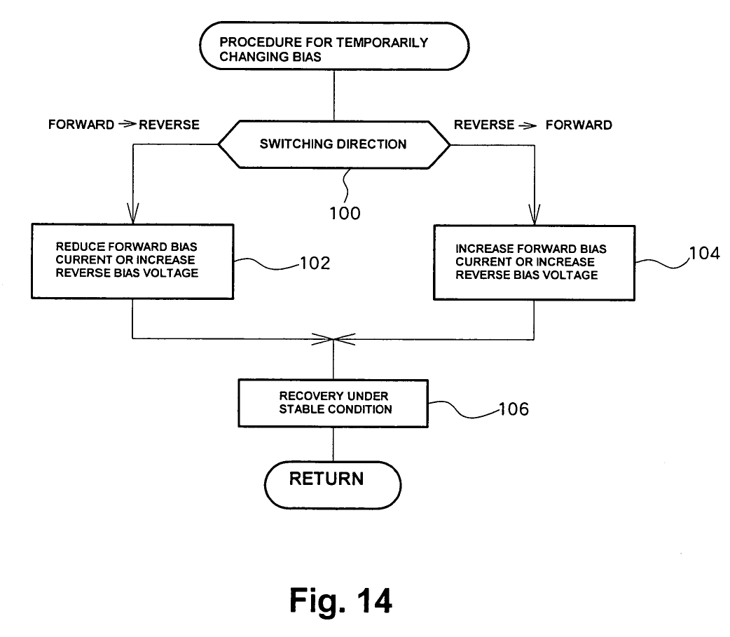

In order to further reduce the time required for switching in the PIN diode, it is possible to control to temporarily increase or decrease the bias voltage or current during a very short time including the instance of switching. For example, each of the drive circuits 31 and 32 (and drive circuits 35-37 in alternative embodiments to be described below) may be constructed to have a structure shown in FIG. 13. In this circuit structure, when a semiconductor switch S11 in a drive circuit is switched on, a positive power supply 44 is connected to the PIN diode, and when a semiconductor S21 is switched on a negative power supply 45 is connected to the PIN diode. The positive power supply 44 supplies a forward bias current and the negative power supply 45 applies a reverse bias voltage to the PIN diode. A controller circuit 43 is a circuit which is provided in addition to or as a part of each of the drive circuits 31 and 32 and selectively switches the semiconductor switches S11 and S21 on and off by applying a control voltage to a control electrode (a gate in FIG. 13 because a FET is used as the semiconductor switch) of semiconductor switches S1 and S2 through bias circuits 46 and 47. In order to reduce the time required for switching, the controller circuit 43 executes a procedure to temporarily change one or both of the forward bias current and the reverse bias voltage by controlling the positive power supply 44 and the negative power supply 45. In an example process shown in FIG. 14, during switching from forward to reverse (100), the controller circuit 43 temporarily reduces the forward bias current, for example, from 0.5 A to 0.25 A and temporarily increases the reverse bias voltage, for example, from −500 V to −400 V (102). On the other hand, during switching from reverse to forward (100), the controller circuit 43 temporarily increases the forward bias current, for example, from 0.5 A to 1 A and temporarily increases the reverse bias voltage, for example, from −500V to −400V (104). When the biasing condition is stabilized after switching or a time sufficient for stabilization elapses, the controller circuit 43 restores the normal bias condition from the temporarily changed bias condition (106). By executing such a procedure, it is possible to obtain advantages such as reduction in required time of switching and consequently in possibility of loss of data bits, and reduction of heat generation or power consumption in the PIN diode, and consequently realization of high-power switching. Refer also to Reference 6 described above. Because the procedure of FIG. 14 is based on a circuit of FIG. 13, the forward bias current is positive and the reverse bias voltage is negative, but these polarities may be inverted depending upon the specific design. Using the power supply controlling functionality, it is possible to control such that a power supply which is not being used is stopped in normal operation. In addition, although in FIGS. 13 and 14, an example structure is shown with one positive power supply 44 and one negative power supply 45, it is also possible also to reduce the time required for switching in a circuit having more power supplies by applying the procedure described above or a similar procedure.

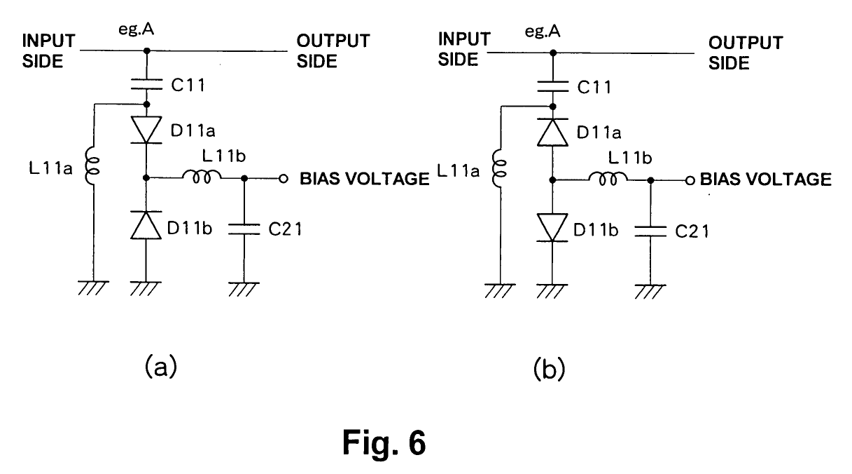

It is also possible to employ a back-to-back connection as shown in FIG. 6 in which two PIN diodes D11a and D11b are connected pointing in opposite directions. With such a structure, it is possible to reduce required reverse bias voltage, reduce distortion, etc. Because two diodes are used, two inductors (L11a and L11b) are placed in FIG. 6 corresponding to the inductor L11 of FIG. 2.

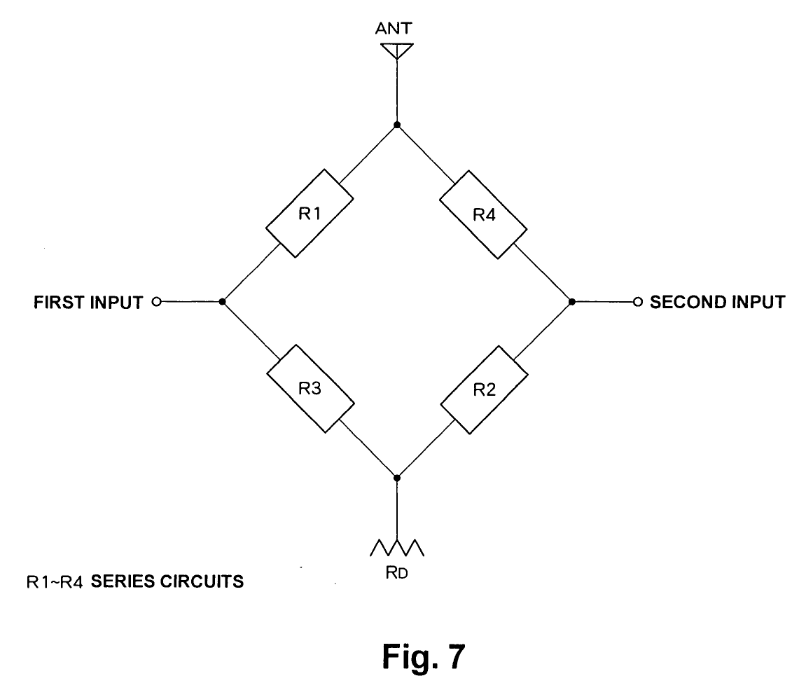

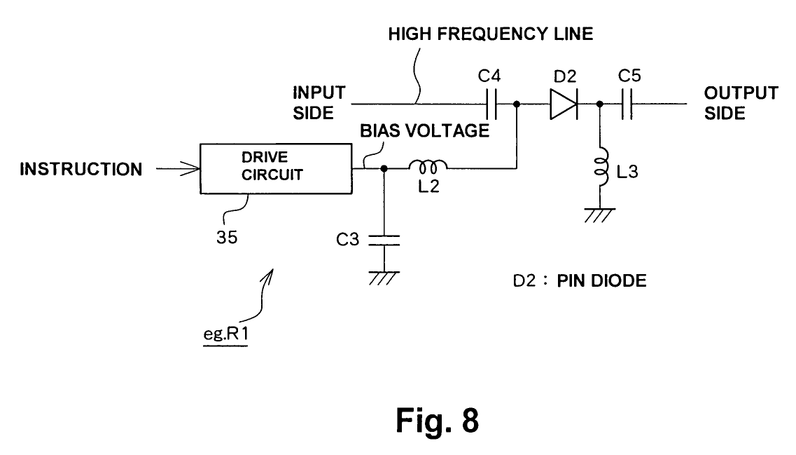

In the above-described embodiment, a shunt circuit is used as the switching circuit. Alternatively, it is possible to employ series circuits in some or all of the switching circuits (refer also to Reference 3 described above). FIG. 7 shows an example in which series circuits R1-R4 are provided, one on each high frequency line. Because a series circuit is stopped when the bias power supply is stopped and is inferior to a shunt circuit in heat dissipating capability, etc., the series circuit is more suited to a low-power structure than to a high-power structure. On the other hand, with the series circuit in one step as shown in FIG. 7, because the λ/4 line is not necessary, a switch having a wider bandwidth can be obtained through the use of the series circuits. A series circuit can be realized by a circuit as shown in FIG. 8. In FIG. 8, a PIN diode D2 is inserted in a central conductor of a high frequency line in series and capacitors C4 and C5 and an inductor L3 are provided in front of and behind the PIN diode D2 for blocking bias voltage. A drive circuit 35 supplies a bias voltage to the PIN diode D2 via the capacitor C3 and inductor L2 in response to an instruction.

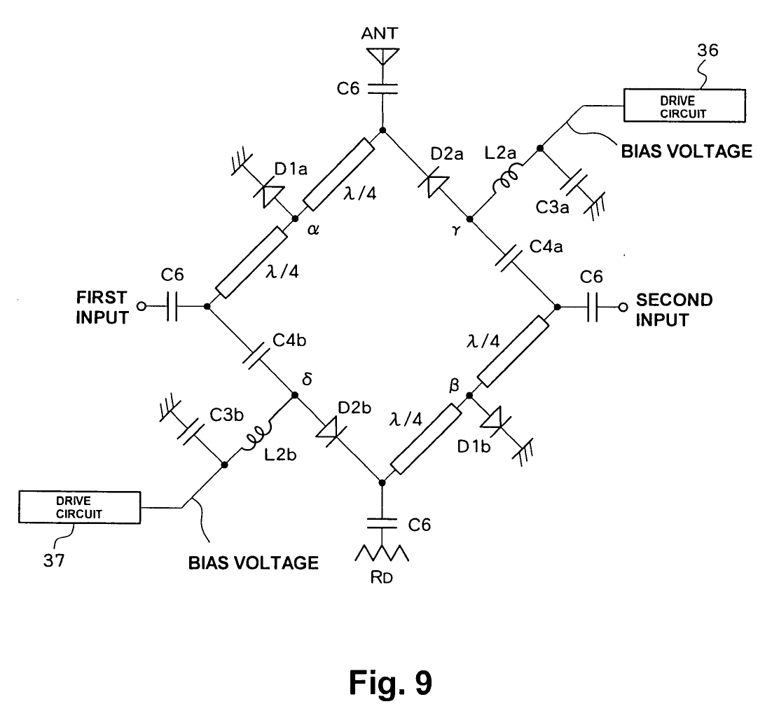

FIG. 9 shows an example structure in which shunt circuits and series circuits are mixed. At a point α on a high frequency line from a first input to a transmission antenna ANT, a PIN diode D1a which Is a shunt circuit is placed and at a point β on a high frequency line from a second input to a dummy load RD, a PIN diode D1b which is a shunt circuit is placed. The points α and β are placed at a position which is separated from the nearest input/output terminal by an electrical length of λ/4. At a point y on a high frequency line from a second input to the transmission antenna ANT, a PIN diode D2a which forms a portion of a series circuit is provided and a PIN diode D2b which forms a portion of a series circuit is provided at a point δ on a high frequency line from the first input to the dummy load RD.

Two drive circuits (36 and 37) are provided. A bias voltage output from the drive circuit 36 is supplied to the PIN diode D2a through a capacitor C3a and an inductor L2a, and further to the PIN diode D1a through a portion of the high frequency line. Similarly, a bias voltage output from the drive circuit 37 is supplied to the PIN diode D2b through a capacitor C3b and an inductor L2b, and further to the PIN diode D1b through a portion of the high frequency line. In order to block the bias voltage, capacitors C4a and C4b are provided at a side, with respect to the points γ and δ, opposite of the PIN diodes D2a and D2b of the series circuits, and a capacitor C6 is provided in each terminal. In this structure, in addition to the advantages that the number of drive circuits is reduced and that the number of signal lines for applying bias voltage is reduced, because the first input is automatically connected to the transmission antenna ANT and the second input is automatically connected to the dummy load RD when the bias power supply is stopped, it is possible to prevent generation of uncertain conditions involved with interruption of the power supply. In addition, by employing multiple step switching circuits, it is possible to improve isolation.

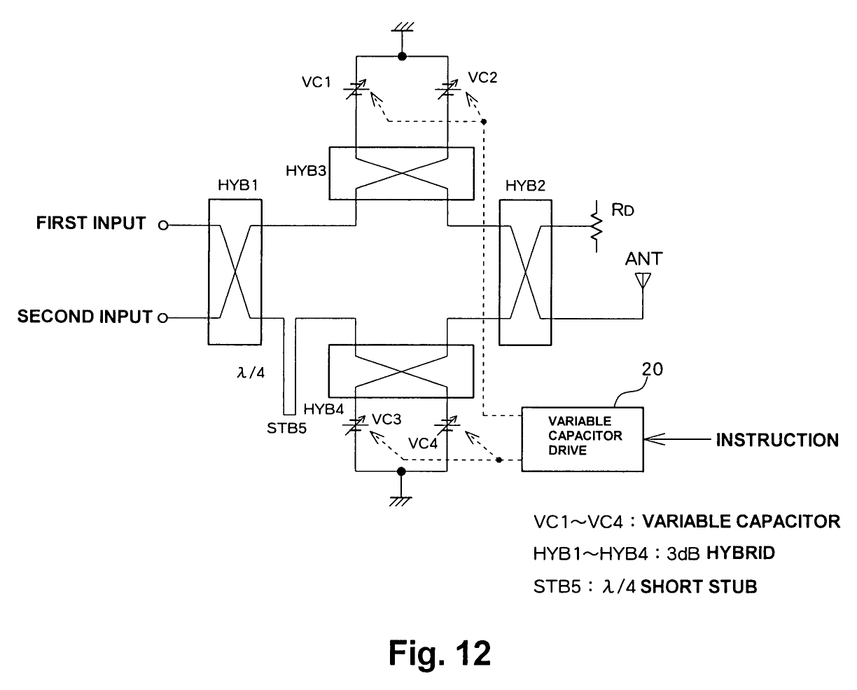

The preferred embodiment described above is an application of the present invention to and an improvement of switches SW1 and SW2 in the conventional structure shown in FIG. 11. However, the present invention may also be applied to the conventional art shown in FIG. 12, for example, by changing the phase shifter to a PIN diode type phase shifter and applying redundancy. In addition, both structures of FIGS. 11 and 12 have a mode to synthesize outputs of two broadcasting device and transmitting the synthesized output. By using the switch SW according to the preferred embodiment of the present invention described above and referring to disclosure of the References described above, it is possible to realize this type of mode.

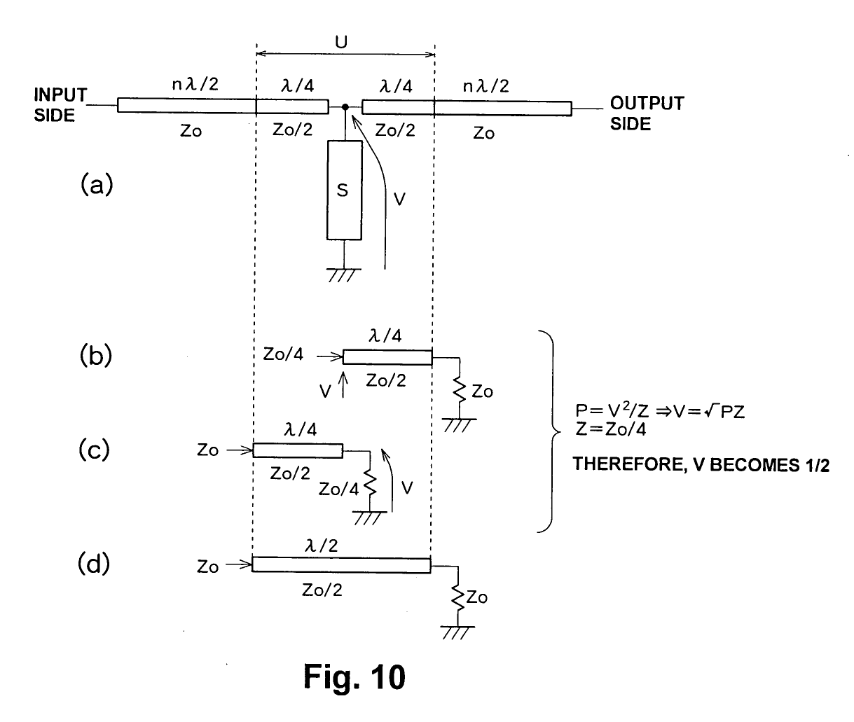

In addition, it is possible to apply a low impedance method to the high frequency lines within the switch SW, in particular in a portion near the shunt circuit. For ease of discussion, a structure is considered in which one shunt circuit is provided on one high frequency line. In the low impedance method, as shown in FIG. 10(a), the intrinsic impedance of a line in front of and behind the shunt circuit S such as, for example, a λ/4 line, is set to, for example, Z0/2 which is ½ of the intrinsic impedance Z0 of the other portions. As shown in FIG. 10(b), the impedance when the output side is seen from the connection point between the high frequency line and the shunt circuit is an impedance when the λ/4 line having an intrinsic impedance of Z0/2 is terminated with the impedance of Z0, and is Z0/4 from known laws. Similarly, as shown in FIG. 10(c), the impedance when the connection point is seen from a position separated by λ/4 in the input side of the connection point is the impedance when the λ/4 line having an intrinsic impedance of Z0/2 is terminated with the impedance of Z0/4, and is Z0 from known laws. In addition, as shown in FIG. 10(d), the impedance when the position which is λ/4 away from the connection point toward the output side is seen from a position which is λ/4 away from the connection point toward the input side is Z0, and therefore, there is no mismatch. Regarding the high frequency voltage appearing at the connection point, because the impedance is reduced to Z0/4, the voltage is reduced to ½ compared to when the low impedance method is not applied, using a formula of V=(PZ)^{1/2}.

Therefore, with the use of the low impedance method, it is possible to use a semiconductor element (PIN diode) having a lower voltage specification. The increase of current due to the reduction in voltage can be compensated by increasing the number of parallel semiconductor elements. A semiconductor element adapted for a high voltage is expensive and, in many cases, difficult to obtain, but a low voltage specification semiconductor element is inexpensive and easy to obtain. Therefore, although there is an increase in the cost associated with the increase in the number of parallel semiconductor elements, a reduction in the cost which exceeds the cost increase can be obtained. With such a configuration, it is possible to realize a switch for high power less expensively and to quickly obtain components. Although, in FIG. 10, the connection point is shown positioned at the center of the λ/2 line, the connection point is not strictly limited to the exact center.

### INDUSTRIAL APPLICABILITY

The present invention can be applied to various switches including a switch for a digital ground wave television broadcasting device.

1. A switch for selectively connecting at least one of a plurality of inputs to a predetermined output, the switch comprising:
a plurality of high frequency lines for high-frequency connecting each input to the output;
a switching circuit provided in each high frequency line for selectively blocking, line by line, the high-frequency connection; and
a drive circuit for driving the switching circuit, wherein
a plurality of switching circuits are provided on at least one of the plurality of high frequency lines, and
the drive circuit is provided for each switching circuit.

2. A switch according to claim 1, wherein
the switching circuit comprises a semiconductor element for conducting or blocking in response to a bias voltage, and
the drive circuit applies the bias voltage to the semiconductor element in the corresponding switching circuit.

3. A switch according to claim 2, wherein
the drive circuit determines a bias condition of the semiconductor element in the corresponding switching circuit based on an output voltage or current of the drive circuit, and
occurrence of abnormality in the drive circuit or in the semiconductor element is detected based on a result of the determination.

4. A switch according to claim 2, wherein
each of the switching circuits is either:
a series circuit in which the semiconductor element is inserted on a central conductor of the corresponding high frequency line such that, when the semiconductor element is conductive, the transmission through the high frequency line is allowed and when the semiconductor element is not conductive, the transmission is blocked, or
a shunt circuit in which a semiconductor element is inserted between the central conductor and a grounding conductor of the corresponding high frequency line such that, when the semiconductor element is conductive, the transmission through the high frequency line is blocked and when the semiconductor element is not conductive, the transmission is allowed.

5. A switch according to claim 4, wherein
at least one of the switching circuits is the shunt circuit.

6. A switch according to claim 5, wherein
the shunt circuit has an automatic overheating detachment component which, when a component of the shunt circuit is excessively heated, detaches the shunt circuit or the heated component from the central conductor of the corresponding high frequency line.

7. A switch according to claim 6, wherein
the automatic overheating detachment component is a coponent having a cushioning characteristic such as a thermal fuse.

8. A switch according to claim 5, wherein
the shunt circuit has a capacitor which blocks a direct current to prevent appearance of the bias voltage on the central conductor and grounding conductor of the corresponding high frequency line.

9. A switch according to claim 5, wherein
in at least one of the plurality of high frequency circuits, a plurality of shunt circuits are provided at a same position on the high frequency line as the switching circuits in parallel to each other.

10. A switch according to claim 5, wherein
in at least one of the plurality of high frequency lines, shunt circuits are provided at different positions on the high frequency line as the switching circuits.

11. A switch according to claim 10, wherein
a line portion having an electrical length of an odd number multiple of λ/4 is provided as a part of the high frequency line between the positions at which the plurality of shunt circuits are provided on the same high frequency line, wherein λ is a carrier wavelength of a signal transmitting through the high frequency line.

12. A switch according to claim 4, wherein
at least one of the plurality of high frequency lines comprises two terminal-side line portions respectively extending from the input and from the output, the terminal-side line portion having an electrical length of a natural number multiple of λ/2 where λ is a carrier wavelength of a signal transmitting through the high frequency line, and a switching circuit-side line portion for connecting between the terminal-side line portions;
one or more of the switching circuits are provided on the switching circuit-side line portion; and
a line portion having an electrical length of an odd number multiple of λ/4 is provided as a part of the switching circuit-side line portion between a switching circuit, among the switching circuits provided on the switching circuit-side line portions, which is the closest to the terminal-side line portion and the terminal-side line portion.

13. A switch according to claim 12, wherein
the switching circuit-side line portion is a rigid line portion which is provided to be detachable from the terminal-side line portion and having a shape which can hold or pinch, and forms a U-link which is a unit for storing the switching circuit or the drive circuit along with the switching circuit.

14. A switch according to claim 13, wherein
the switching circuit to be stored within the U-link is a shunt circuit and the shunt circuit comprises a capacitor for blocking direct current in order to prevent appearance, on a housing of the U-link, of the bias voltage to be applied to the semiconductor element of the shunt circuit.

15. A switch according to claim 13, wherein
a switch is provided on a panel to which the U-link is provided to detect that the U-link is detached or is about to be detached from the panel.

16. A usage of a switch according to claim 13, wherein
a non-element U-link is prepared which is a line portion unit which can be mounted, in place of the U-link, on the panel to which the U-link is to be provided and which has no switching circuit therein; and
the non-element U-link is used instead of the U-link as necessary.

17. A switch for selectively connecting at least one of a plurality of inputs to a predetermined output, the switch comprising:
a plurality of high frequency lines for high-frequency connecting each of the inputs and the output;
a switching circuit provided for each of the high frequency lines for selectively blocking, line-by-line, the high-frequency connection; and
a drive circuit for driving the switching circuit, wherein
each switching circuit comprises a semiconductor element for conducting or blocking in response to a bias voltage,
the drive circuit is a circuit for applying the bias voltage to the semiconductor element in the corresponding switching circuit,
at lease one switching circuit among the switching circuits is a series circuit in which the semiconductor element is inserted in a central conductor of the corresponding high frequency line such that, when the semiconductor element is conductive, transmission through the high frequency line is allowed and when the semiconductor element is not conductive, the transmission is blocked, and the other switching circuits are shunt circuits in which the semiconductor element is inserted between the central conductor and a grounding conductor of the corresponding high frequency line such that, when the semiconductor element is conductive, the transmission through the high frequency line is blocked and when the semiconductor element is not conductive, the transmission is allowed;
a series circuit is provided as the switching circuit in one or more of the plurality of high frequency lines connected to the same input or output and a shunt circuit is provided as the switching element in each of the remaining high frequency lines;
a drive circuit is provided corresponding to the series circuit and a bias voltage supply route from the drive circuit to the shunt circuit is provided corresponding to the shunt circuit; and
a capacitor for direct-current blocking the input or the output with respect to the drive circuit is provided in the input, in the output, or on the high frequency circuit, in order to cause a line portion, among the plurality of high frequency lines, from a series circuit provision position to a shunt circuit provision position, to function as the bias voltage supply route from the drive circuit provided corresponding to the series circuit to the shunt circuit.

18. A switch for selectively connecting at least one of a plurality of inputs to a predetermined output, the switch comprising:
a plurality of high frequency lines for high-frequency connecting each of the inputs and the output;
a switching circuit provided for each of the high frequency lines for selectively blocking, line-by-line, the high-frequency connection; and
a drive circuit for driving the switching circuit, wherein
the switching circuit has a semiconductor element which conducts or blocks in response to a bias voltage;
the drive circuit is a circuit for applying the bias voltage to the semiconductor element in the corresponding switching circuit;
at least one of the switching circuits is a shunt circuit in which the semiconductor element is inserted between a central conductor and a grounding conductor of the corresponding high frequency circuit such that, when the semiconductor element is conductive, a transmission through the high frequency line is blocked and when the semiconductor is non conductive, the transmission is allowed; and
a line portion on the high frequency line which includes a shunt circuit provision position, extends on a side of the input and a side of the output of the shunt circuit provision position and has an electrical length of a natural number multiple of λ/2 is a line portion having a lower intrinsic impedance compared to line portions on the side of the input and on the side of the output seen from the line portion, wherein λ is a carrier wavelength of a signal transmitting through the high frequency line.

19. A switch according to claim 18, wherein
a plurality of switching circuits are provided in at least one of the plurality of high frequency lines, and
the drive circuit is provided for each switching circuit.

20. A switch according to claim 2, wherein
the semiconductor element in the switching circuit is a semiconductor element which conducts or blocks by switching of forward bias and reverse bias, and
means for controlling a bias voltage or a current to temporarily increase or decrease in order to shorten the time required for switching when the bias for the semiconductor element is switched between forward and reverse is provided attached to or within the drive circuit.

21. A switch according to claim 17, wherein
the semiconductor element in the switching circuit is a semiconductor element which conducts or blocks by switching of forward bias and reverse bias, and
means for controlling a bias voltage or a current to temporarily increase or decrease in order to shorten the time required for switching when the bias for the semiconductor element is switched between forward and reverse is provided attached to or within the drive circuit.

22. A switch according to claim 18, wherein
the semiconductor element in the switching circuit is a semiconductor element which conducts or blocks by switching of forward bias and reverse bias, and
means for controlling a bias voltage or a current to temporarily increase or decrease in order to shorten the time required for switching when the bias for the semiconductor element is switched between forward and reverse is provided attached to or within the drive circuit.
